(19) United States
(12) Patent Application Publication
(10) Pub. No.: US 2016/0044281 A1
(43) Pub. Date: Feb. 11, 2016

(54) Portable Surveillance Device

(71) Applicant: Brenton Dane Canfield, Perrsyburg, OH (US)

(72) Inventor: Brenton Dane Canfield, Perrsyburg, OH (US)

(73) Assignee: Smart Digital LLC, Ashland, OH (US)

(21) Appl. No.: 14/453,976

(22) Filed: Aug. 7, 2014

(51) Int. Cl. H04N 7/18; H04W 40/04; H04N 5/225

(52) U.S. Cl. CPC H04N 7/181; H04N 5/2252; H04W 40/04

(57) ABSTRACT

A surveillance device includes a traffic barrel that has a sidewall and holes in the sidewall The holes are uniformly spaced apart about a circumference of the traffic barrel. Cameras are contained in the traffic barrel. Each camera has a light-receiving aperture that is aligned with a respective one of the holes in order for the aperture to provide the camera with a field of vision for the camera to capture surveillance images. The surveillance device further includes a wireless communication device configured to wirelessly transmit the surveillance images.

### TECHNICAL FIELD

This relates to video surveillance devices.

### BACKGROUND

Video surveillance devices are typically used to monitor activity in a geographic area under surveillance. A video surveillance device typically includes a camera that captures images of the area. It further includes a recording device that records the images in a video storage medium and/or a transmitter that transmits the images from the camera to a monitoring station for view by security personnel.

### BRIEF DESCRIPTION OF THE DRAWINGS

FIG. 1 is a perspective view of a surveillance device.

FIGS. 2, 3 and 4 are respectively a front view, a side view and a top view of the surveillance device.

FIG. 5 is a sectional view of the barrel, taken at line 5-5 in FIG. 2, illustrating how four cameras are positioned within the surveillance device.

FIGS. 6, 7 and 8 are respectively a front view, a side view and a top view of electrical equipment contained in the surveillance device.

FIG. 9 is a bird's-eye view of a network of surveillance devices, each identical to the surveillance device of FIG. 1, used in an area under surveillance.

FIG. 10 is a schematic drawing of a CPU and networking circuit of the surveillance device.

FIG. 11 is a schematic drawing of an inputs-and-outputs section of the surveillance device.

FIG. 12 is a section interconnection diagram of the surveillance device.

FIG. 13 is a Power Over Ethernet (POE) section of the surveillance device.

FIG. 14 is a power input section of the surveillance device.

FIG. 15 is a voltage regulation section of the surveillance device.

FIG. 16 is a trace diagram of a circuit board of the surveillance device.

### DETAILED DESCRIPTION

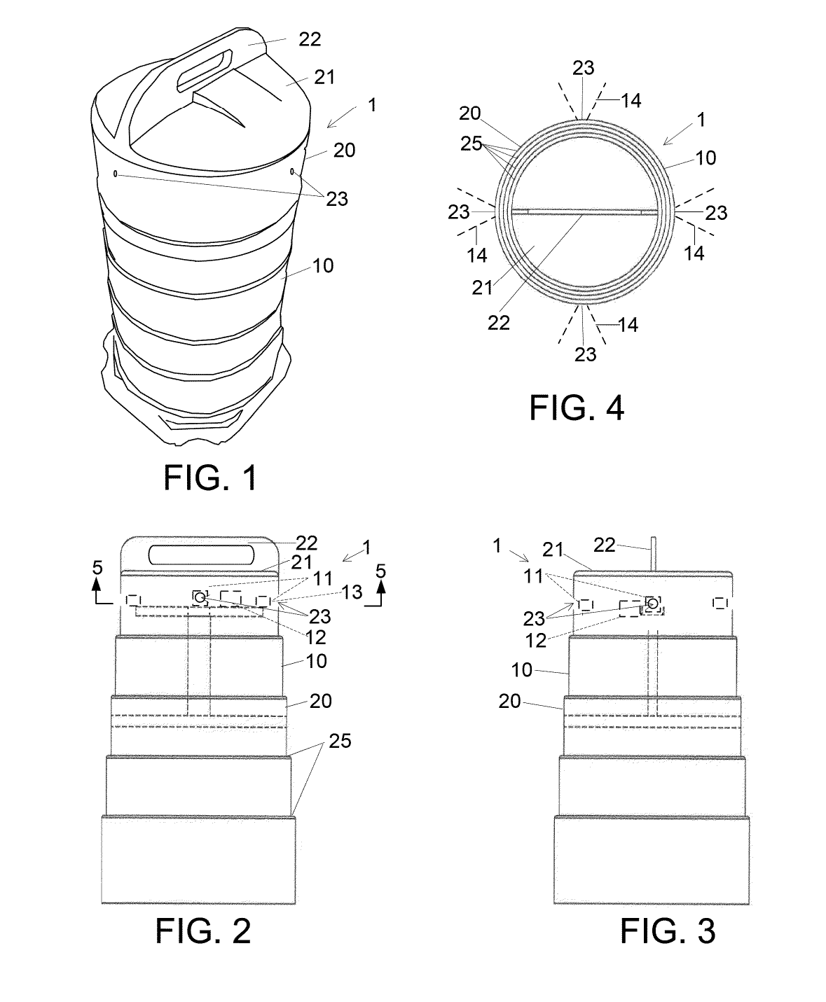

FIGS. 1-4 show an example surveillance device 1 that can be used to monitor activity, such as human activity, in a geographic area, typically for security purposes. The surveillance device (SD) includes electrical equipment that is housed in a traffic barrel 10. The equipment includes cameras 11 for capturing images and a wireless communication device 12 for transmitting the images to a monitoring facility.

The cameras 11 capture still images and/or video images. In this example, each camera 11 is a pinhole cameras, with a light-receiving aperture 13 that is less than 1 mm in diameter. This aperture configuration reduces the likelihood of the camera 11 being recognized as a camera by passersby, relative to if the light aperture were larger with a recognizable lens. The cameras 11 in this example are IP PoE (Internet protocol, Power over Ethernet) cameras.

The cameras 11 are equally spaced apart about the barrel's circumference. Since there are four cameras 11 in this example, the cameras 11 are spaced apart by 90 degrees, providing four respective fields of vision 14 (FIG. 4) outward from a central vertical axis of the barrel.

The wireless communication device 12 is capable of both receiving and transmitting the images, image metadata and control data (transmitted by a monitoring station for controlling the the SD's operation). The wireless communication device 12 comprises a wireless access point (WAP) device that includes a wireless router that can communicate with other SDs. The wireless communication device 12 serves three functions—as a transmitter, repeater and gateway: Serving as a transmitter, the wireless communication device 12 transmits images from its own cameras 11 to another SD. As a repeater, the wireless communication device 12 receives images from another SD and forwards those images to a yet another SD. As a gateway, the wireless communication device 12 forwards the images, received from its own SD's camera and from other devices, to a base station, which in turns forwards the images to a wired network using a Wi-Fi or related standard. To function as a gateway, the device 12 includes a DVR (digital video recorder) and 4G modem for internet access.

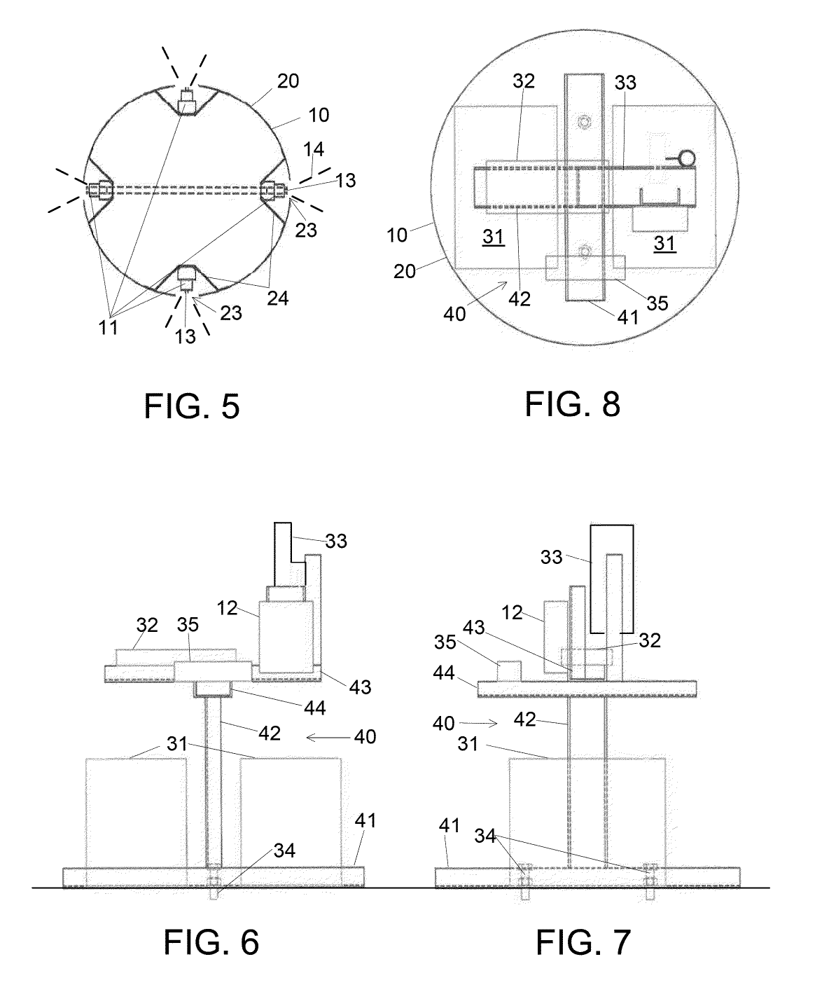

The barrel 10 includes a generally cylindrical sidewall 20, a top surface 21 and a handle 22 projecting upward from top surface 21. The barrel's sidewall 20 has four holes 23. They are aligned vertically and circumferentially with the four apertures 13 of the four cameras 11 in order to provide a field of vision through each hole 23. Therefore, the holes 23, like the camera apertures 13, are uniformly spaced apart about the circumference of the barrel 10. Each camera 11 is secured to the barrel 10 by a bracket 24 as shown in FIG. 5.

Traffic barrels, also called construction barrels, are commonly used by construction workers in a construction area. The barrels typically warn pedestrians and motorists of construction activity in the area and channel pedestrian and vehicular traffic away from the area. Traffic barrels tend to share the following distinctive features that enable people to identify them as traffic barrels: Traffic barrels typically have a sidewall shape that is generally cylindrical, with a diameter that decreases with increasing distance from the ground. The decrease may be rendered by a smoothly tapering diameter. Additionally or alternatively, as in the this example, the diameter decrease is rendered by distinct ledges 25 (FIG. 2) where the diameter abruptly transitions from a larger diameter to a smaller diameter. The barrels are molded from red or orange plastic. Shiny bands of different colors—typically white, light silver, red or orange—surround the barrel. The barrels may have a height in the range 2-4 feet, and a diameter in the range 2-3 feet. The SD housing 10 in this example is called a “traffic barrel” or “construction barrel” in that it looks like a traffic barrel or construction barrel, even though it may not have been manufactured for, or used for, serving a traffic/construction barrel's core function of channeling traffic.

Traffic barrels are particularly well suited for hiding surveillance cameras for the following reasons: Traffic barrels are rugged. They are inconspicuous because they are ubiquitous. They are common to all environments, including city and rural, developed and back country road, roadway and open space. They enable surveillance that is covert, since passersby do not expect surveillance from a traffic barrel. Their being deployed temporarily does not arouse suspicion. They are portable and easily deployable, since they can be stored in a warehouse, transported by truck, and manually rolled from the truck to the surveillance site. They are inherently a standalone unit, in that they are not designed to, or expected by passersby to, connect to or accompany something else. They are also sufficiently large, heavy and stable to withstand strong winds. Theft and unauthorized removal are unlikely for three reasons: 1) Their large size, heaviness, stability makes their removal cumbersome. 2) Their bright colors and universal expectation by passersby for only construction workers to handle them makes their removal by a non-construction worker conspicuous. 3) There is a lack of desire by people to own one. Housings other than traffic barrels, that include all or some of the traffic barrel features mentioned above, can be used. One example is a traffic cone.

As shown in FIGS. 6-8, the equipment further includes the following electrical supply devices: Two 12VDC batteries 31 power the cameras 11. A 24VDC battery 32 and a 48VDC battery 33 power other components of the electrical equipment in the barrel. The 12VDC battery may be recharged from two electrical terminals 34 when the SD is in storage. An inverter 35 converts the 12VDC to both 24VDC and 48VDC to power the 24VDC and 48VDC batteries 32, 33.

As shown in FIGS. 5-6, the equipment is supported by a support structure 40. The support structure 40 includes a tray 41 that is secured to the barrel's sidewall 20 (FIG. 2). The tray 41 carries the two 12VDC batteries 31. A post 42 extends upward from the tray and supports a two horizontally extending crossbars—an upper crossbar 43 perpendicularly overlying a lower crossbar 44. The upper crossbar 43 supports and secures the wireless communication device 12 and the 24VDC and 48VDC batteries 32, 33. The lower crossbar 44 supports the inverter 35.

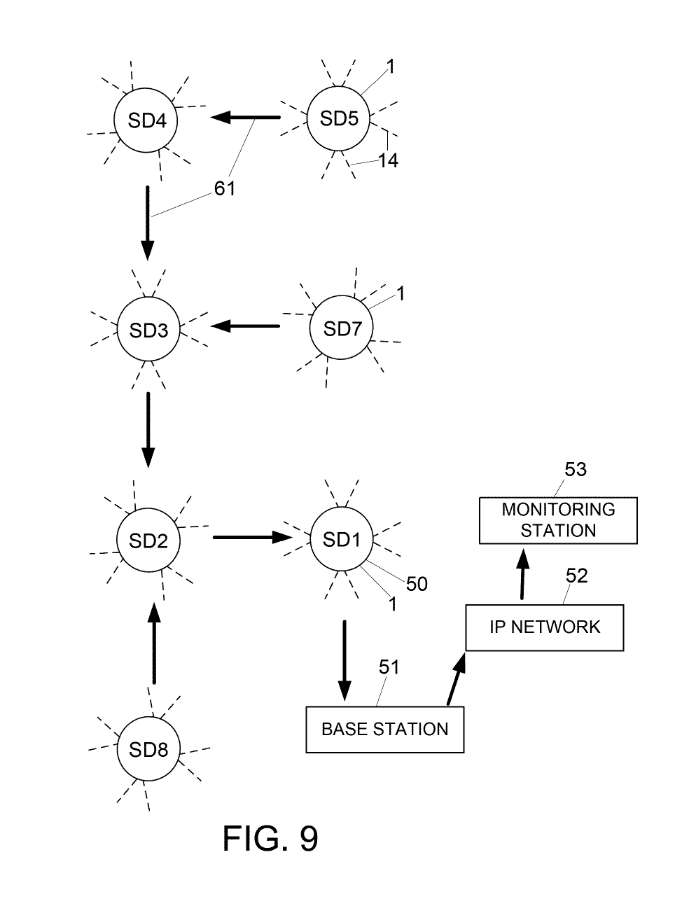

FIG. 9 is a bird's-eye view of a system of multiple surveillance devices (SDs) like the SD of FIGS. 1-8, being used to monitor an area. The images from all of the devices 1 are communicated (arrow 61) to one of the devices, designated a gateway device 50, which in turn transmits the images to an IP base station 51. The base station 51 forwards the images through an IP (network protocol) network 52 to a monitoring station 53. In the monitoring station 53, the images are processed using video management software (VMS) and displayed to security personnel that monitor the images.

The SDs 1 communicate with each other using their wireless communication devices 12 (FIG. 2) by forming a mesh network. Each SD 1 serves as a node of the mesh network, in that each SD 1 is capable of communicating with each other SD 1 in the network, to convey the surveillance images to the IP network. The images are channeled from one SD to the next until the gateway device 50 is reached. The mesh network may be a fully connected network in which each SD 1 is connected to each other DS 1.

The mesh network uses self-healing algorithms to reconfigure communication routes around broken or blocked paths, so that the images will continue to be received by the monitoring station 53 when a SD becomes lost or inoperative. In such a case, each SD 1 that communicated through the now-inoperative device automatically connects to another SD 1 in line. The gateway device 50 may function as a standalone unit, in that it would not require other SDs to be connected to it. Due to a cooperative nature of the SDs 1 in reconfiguring communication channels, any number of SDs can be included. And the SDs can cover any size geographic area, even a geographic area extending beyond the communication range of one SD, since the images of even the farthest SD from the gateway 50 is forwarded by the other SDs to reach the gateway 50. Each time security personnel add a SD 1 to the mesh network or remove a SD 1 from the mesh network, the SDs cooperatively and automatically adapt by rerouting the communication channels. In the example of FIG. 9, the SDs 1 are positioned such that the fields of vision 14 of at least some of the SDs intersect. The SDs 1 are oriented in different directions. For example, the fields of vision 14 may be oriented in the cardinal directions (north, south, east, west) in some SDs, and angled 45 degrees to the cardinal directions in others, and angled 23 degrees to the cardinal directions in another.

Each SD 1 is able to wirelessly receive images from any of the other SD and wirelessly forward the received images to any other of SD. The SD 50 that serves as a gateway device receives the images from the other SDs and forwards the received images to the base station 51.

One communication route (arrows 61) for forwarding the images extends through a series of SDs in a particular sequence of the communication devices. That sequence is in the order SD5-SD4-SD3-SD2-SD1. At the start of the surveillance operation, and also during the surveillance operation, the SDs may cooperatively rearrange the sequence to optimize signal strength of transmission signals from each SD in the series to the next. For example, in response to change of signal strength or due to SD4 being moved away, the SDs may cooperatively and automatically change the sequence to SD5-SD7-SD3-SD2-SD1. In this example, SD4 and SD5 are both not within range for wirelessly communicating directly with gateway SD1, but their images can nevertheless reach gateway SD 1 by being forwarded from SD to SD in the series of SDs.

The SDs can detect when one of the SDs in the series, such as SD4, is removed. In response, they can cooperate with each other to automatically reroute the communication route through the remaining SDs in the series, such as through the sequence SD5-SD3-SD2-SD1. Alternatively, they may add another SD that was not previously in the series, such as SD7, to the series, to maintain the forwarding of the images from SD5 to gateway SD1.

Security personnel may store the SDs in a warehouse where the SDs are kept charged. The personnel may then truck the SDs to a surveillance site and place the SDs into place as shown in FIG. 9. The SDs 1 may then cooperatively designate one SD to serve as the gateway SD 50 for forwarding the images from all the SDs to the base station 51. The SDs 1 may then also cooperatively determine a route of communication for communicating the images from even the most distal SD (SD5) to the gateway SD 50 (SDI). When security personnel move one of the SDs in the series to a different location within the surveillance site, the SDs 1 detect the move and, in response, cooperatively rearrange the communication sequence to optimize signal strength between successive SDs.

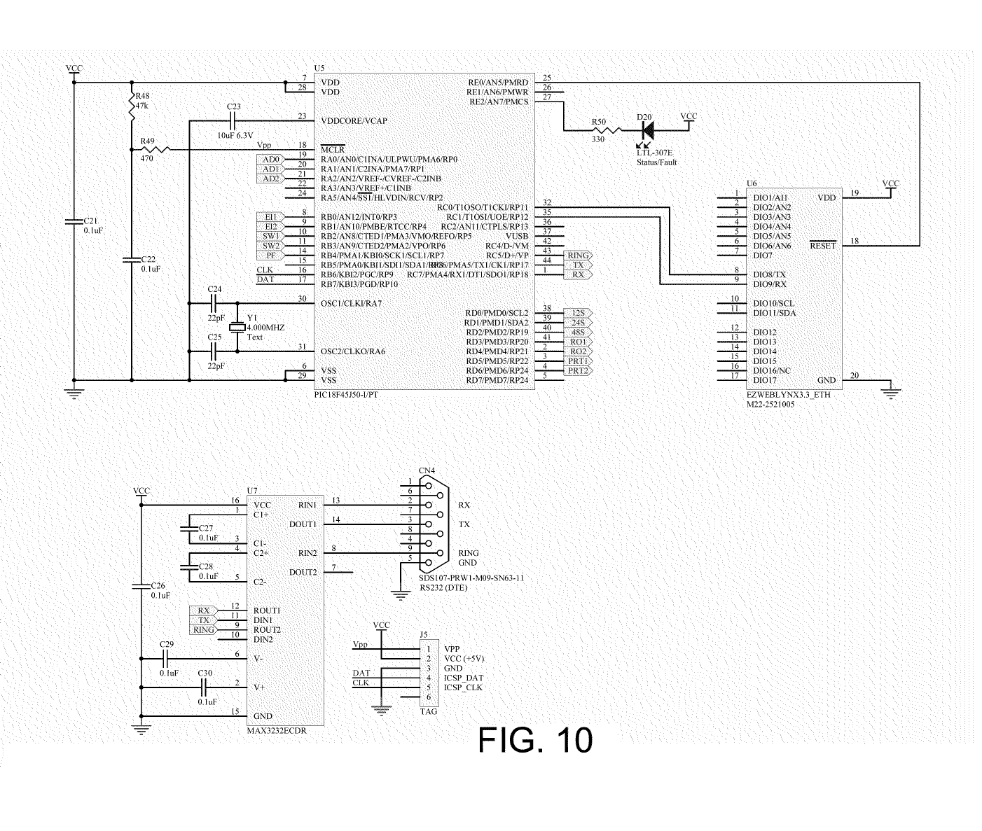

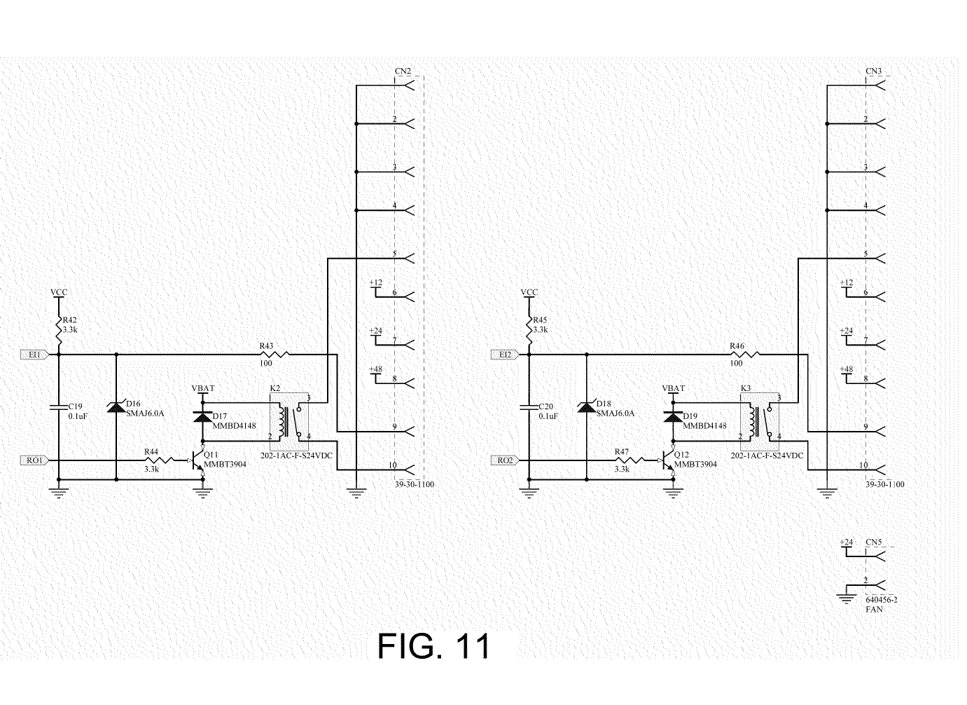

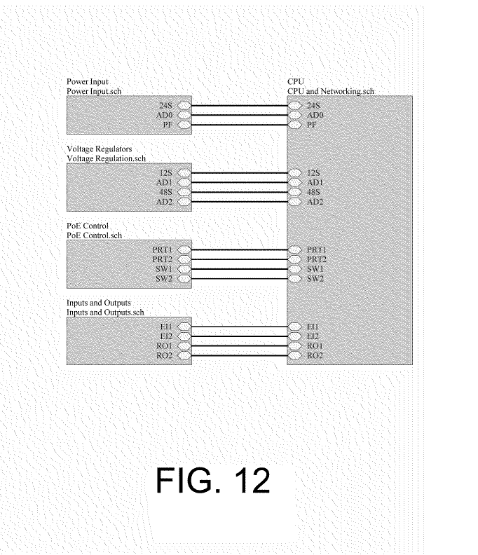

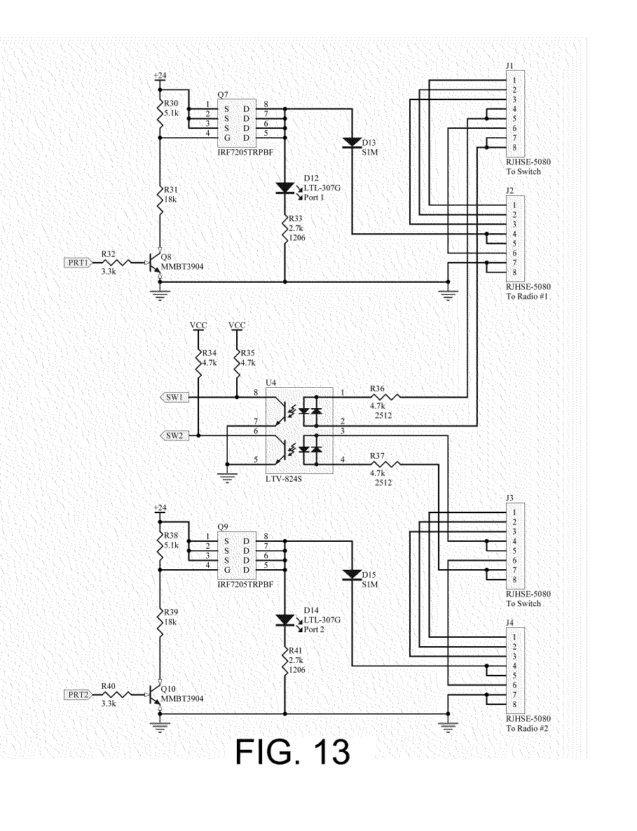

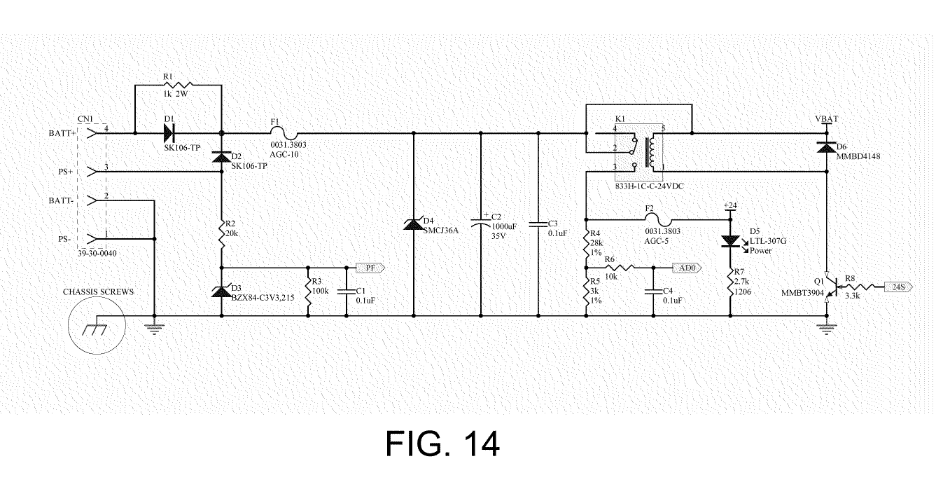

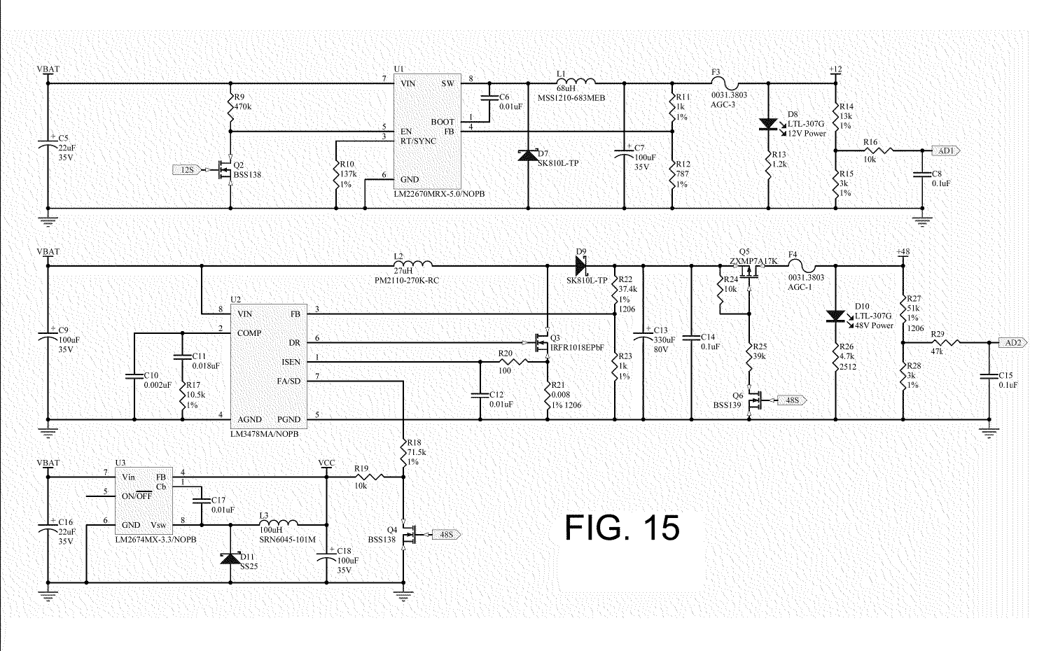

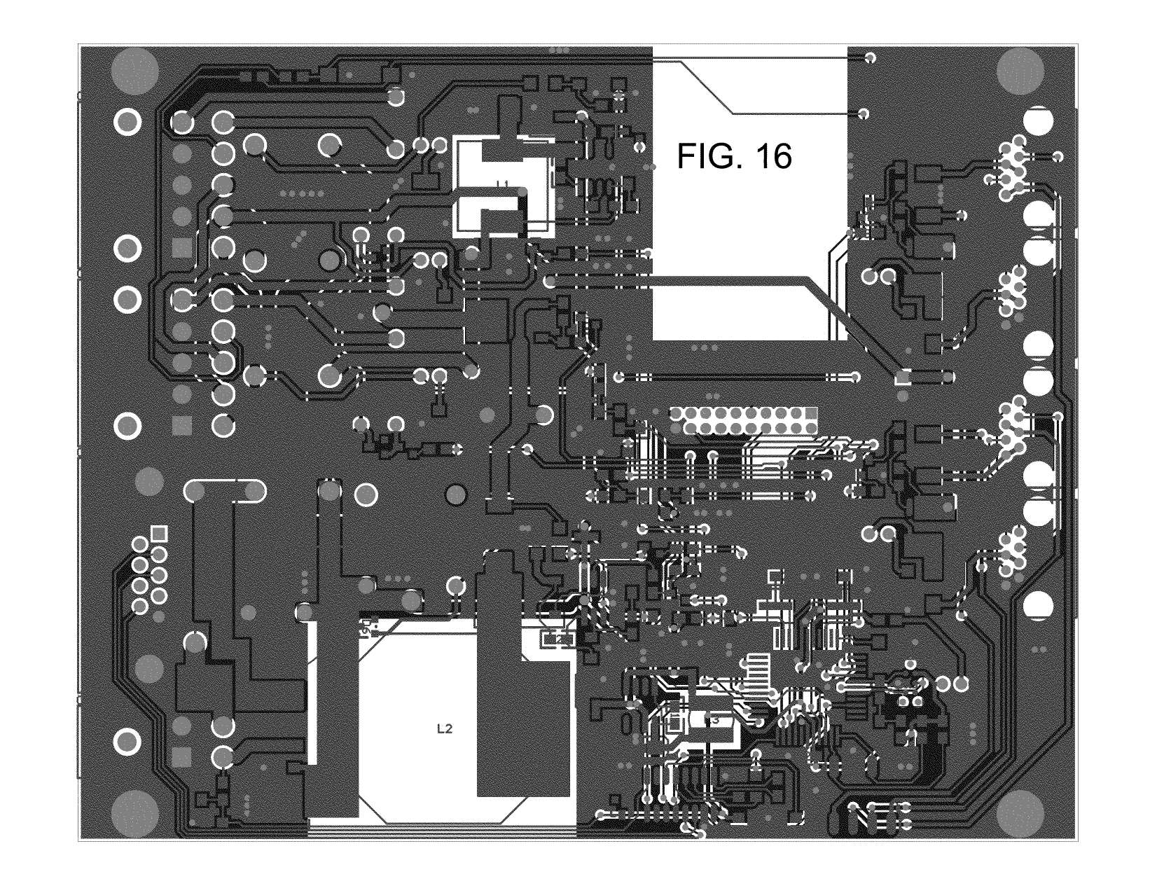

FIGS. 10-16 are schematic diagrams of a control module of the surveillance device. Component abbreviations included in FIGS. 10-16 are defined as follows:

### Through Hole Assembly

C2—Incoming power filter capacitor
CN1—24v and battery connector
CN2—12, 24, 48 VDC power output, input and contact outputs
CN3—12, 24, 48 VDC power output, input and contact ouputs
CN4—RS232 console interface

### D5—Status LED

### D8—Status LED

### D10—Status LED

### D12—Status LED

### D14—Status LED

F1—Main input fuse and DC output fuse
F2—Main input fuse and DC output fuse
F3—Main input fuse and DC output fuse
F4—Main input fuse and DC output fuse
J1—PoE injector ports
J2—PoE injector ports
J3—PoE injector ports
J4—PoE injector ports
K1—24v power switch
K2—Dry contact output
K3—Dry contact output
R1—Current limiting resistor
U6—802.11 or Ethernet module (EZ Web Lynx)

### Surface Mount Assembly

C1—Bypass capacitors
C3—Bypass capacitors
C4—Bypass capacitors
C8—Bypass capacitors
C15—Bypass capacitors
C19—Bypass capacitors
C20—Bypass capacitors
C21—Bypass capacitors
C22—Bypass capacitors
C26—Bypass capacitors
C27—Bypass capacitors
C28—Bypass capacitors
C29—Bypass capacitors
C30—Bypass capacitors
C5—filter capacitor
C16—filter capacitor
C6—bootstrap capacitor
C12—bootstrap capacitor
C17—bootstrap capacitor
C7—filter capacitor
C9—filter capacitor
C18—filter capacitor
C10—compensation capacitor
C11—compensations capacitor
C13—filter capacitor
C14—filter capacitor
C23—Micro controller filter capacitor
C24—crystal oscillator load capacitor
C25—crystal oscillator load capacitor
D1—polarity protection and isolation diode
D2—polarity protection and isolation diode
D3—power failure detection circuit (Zener diode)
D4—surge suppression diode
D6—clamping diode
D17—clamping diode
D19—clamping diode
D7—switching regulator Schottky diode
D9—switching regulator Schottky diode
D11—switching regulator Schottky diode
D13—polarity protection diode for PoE ports
D15—polarity protection diode for PoE ports
D16—input line surge suppression diode
D18—input line surge suppression diode
L1—12v switching regulator storage inductor
L2—48v switching regulator storage inductor
L3—3.3v switching regulator storage inductor
Q1—Driver transistor
Q6—Driver transistor
Q8—Driver transistor
Q9—Driver transistor
Q10—Driver transistor
Q2—voltage regulator control transistor
Q4—voltage regulator control transistor
Q5—PoE switching transistor
Q7—PoE switching transistor
R2—Power failure detection circuit resistor
R3—Power failure detection circuit resistor
R4—24v DC monitoring circuit resistor
R5—24v DC monitoring circuit resistor
R6—24v DC monitoring circuit resistor
R7—LED current limiting resistor
R30—LED current limiting resistor
R38—LED current limiting resistor
R47—LED current limiting resistor
R13 —LED current limiting resistor
R26—LED current limiting resistor
R33—LED current limiting resistor
R34—LED current limiting resistor
R9—12v regulator control circuit resistor
R10—12v regulator compensation resistor
R11—12v regulator feedback circuit resistor
R12—12 regulator feedback circuit resistor
R14—12v monitoring circuit resistor
R15—12v monitoring circuit resistor
R16—12v monitoring circuit resistor
R17—48v compensation resistor
R18—48v control circuit resistor
R19—48v control circuit resistor
R20—48v current monitoring circuit
R21—48v current monitoring circuit
R22—48v regulator feedback circuit
R23—48v regulator feedback circuit
R24—48v control circuit
R25—48v control circuit
R27—48v monitoring circuit
R28—48v monitoring circuit
R29—48v monitoring circuit
R30—Port1PoE switch circuit
R31—Port 1 PoE switch circuit
R34—PoE monitoring circuit
R35—PoE monitoring circuit
R36—PoE monitoring circuit
R37—PoE monitoring circuit
R38—Port 2 PoE switch circuit
R39—Port 2 PoE switch circuit
R42—Input circuit for main connector
R43—Input circuit for main connector
R45—Input circuit for auxiliary connector
R46—Input circuit for auxiliary connector
R48—Micro controller reset circuit
R49—Micro controller rest circuit
U1—12v switching regulator integrated circuit (1C)
U2—48v switching regulator integrated circuit (1C)
U3—3.3v switching regulator integrated circuit (1C)
U4—Opto isolator for PoE ports
U5—Micro controller
U7—RS232 driver integrated circuit
Y1—4 MHZ crystal for micro controller oscillator circuit

The components and procedures described above provide examples of elements recited in the claims. They also provide examples of how a person of ordinary skill in the art can make and use the claimed invention. They are described here to provide enablement and best mode without imposing limitations that are not recited in the claims.

1. A surveillance device comprising:
a traffic barrel including a sidewall and holes in the sidewall, the holes being uniformly spaced apart about a circumference of the traffic barrel;
cameras contained in the traffic barrel, each camera having a light-receiving aperture that is aligned with a respective one of the holes in order to provide the camera with a field of vision through the respective hole for the camera to capture surveillance images; and
a wireless communication device contained in the traffic barrel, configured to wirelessly transmit the surveillance images.

2. The surveillance device of claim 2 wherein the number of the cameras is four.

3. The surveillance device of claim 1 further comprising one or more batteries, contained in the traffic barrel, for powering the cameras and the communication device.

4. The surveillance device of claim 1 wherein the communication device is configured to receive images from another surveillance devices and transmit the received images.

5. A surveillance system comprising:
surveillance devices, each including:
a traffic barrel that has a sidewall and a hole in the sidewall;
a camera contained in the traffic barrel, the camera having a light-receiving aperture that is aligned with the hole in order to provide the camera with a field of vision through the hole for the camera to capture surveillance images; and
a wireless communication device contained in the traffic barrel, configured to wirelessly transmit the surveillance images.

6. The system of claim 5 wherein:
the hole is one of multiple holes in the sidewall;
the camera is one of four cameras in the barrel, with each camera having a light-receiving aperture that is aligned with a respective one of the holes in order to provide the camera with a field of vision for the camera to capture surveillance images; and
the camera apertures are uniformly spaced apart about a circumference of the traffic barrel.

7. The system of claim 5 wherein the surveillance devices are positioned such that the fields of vision of at least two of the surveillance devices intersect.

8. The system of claim 5 wherein each surveillance device is configured to be able to (i) wirelessly receive images from any of the other surveillance devices and (ii) wirelessly forward the received images to yet another of the surveillance devices.

9. The system of claim 8 wherein each of the surveillance devices is in communication with each of the other surveillance devices.

10. The system of claim 8 wherein one of the surveillance devices is serving as a gateway device by receiving the images from the other surveillance devices and forwarding the received images to a base station.

11. The system of claim 8 wherein the surveillance devices include a surveillance device that is not within range for communicating directly with the gateway device, and whose images are forwarded through a series of the surveillance devices to the gateway device.

12. The system of claim 11 wherein at least one of the surveillance devices in the series is not within range for communicating directly with the gateway device.

13. The system of claim 11 wherein the surveillance devices are configured to:
detect when one of the surveillance devices in the series is removed, and
in response to the detecting, automatically reroute communication through the remaining surveillance devices in the series so that the images of the distal surveillance device continue to be forwarded to the gateway device.

14. The system of claim 11 wherein the surveillance devices are configured to:
detect when one of the surveillance devices in the series is removed, and
in response to the detecting, automatically reroute communication by adding another one the surveillance devices to the series for forwarding the images of the distal device to the gateway device.

15. The system of claim 8 the communication extends through the series in a particular sequence of the surveillance devices, and the surveillance devices are configured to cooperatively rearrange the sequence to optimize signal strength from each surveillance device in the series to the next.

16. The system of claim 5 wherein each surveillance device includes one or more batteries, contained in the traffic barrel, for powering the camera and the wireless surveillance device.

17. A method for use with the system of claim 5, the method comprising:
placing, by a user of the surveillance devices, the surveillance devices into a surveillance environment; and
the surveillance devices cooperatively designating one of the surveillance devices to serve as a gateway device for forwarding the images from the other surveillance devices to a base station; and
the surveillance devices cooperatively determining a route of communication, for communicating the images from a distal one of the surveillance device to the gateway device, that extends through a series of the surveillance devices.

18. The method of claim 17 further comprising:
removing, by the user, one of the surveillance devices in the series;
the surveillance devices detecting that one of the surveillance devices in the series has been removed; and
in response to the detecting, the surveillance devices automatically rerouting the communication route through the remaining surveillance devices in the series so that the images of the distal surveillance device continue to be forwarded to the gateway device.

19. The method of claim 17 further comprising:
removing, by the user, one of the surveillance devices in the series;
the surveillance devices detecting that one of the surveillance devices in the series is removed; and
in response to the detecting, automatically rerouting the communication route to add another one the surveillance devices to the series for forwarding the images of the distal device to the gateway device.

20. The method of claim 17 further comprising:
moving, by the user, one of the surveillance devices in the series to a different location;
the surveillance devices detecting a change in signal strength between the surveillance devices caused by the moving; and
in response to the detecting, the surveillance devices cooperatively rearranging a sequence with which the communication route extends through the series, to optimize signal strength between successive surveillance devices.
